(19) United States
(12) Patent Application Publication
(10) Pub. No.: US 2005/0238182 A1
(43) Pub. Date: Oct. 27, 2005

(54) Prescription remote-control system

(75) Inventors: Ching-Tu Shih, Tainan Hsien (TW); Chin-Tang Huang, Tainan Hsien (TW)

Correspondence Address: BACON & THOMAS, PLLC, 625 SLATERS LANE, FOURTH FLOOR, ALEXANDRIA, VA, 22314, US

(73) Assignee: Tonic Fitness Technology, Inc., Tainan Hsien (TW)

(21) Appl. No.: 10/817,826

(22) Filed: Apr. 6, 2004

(51) Int. Cl. H04B 3/00; H04B 1/00

(52) U.S. Cl. 381/77; 381/124

(57) ABSTRACT

A prescription remote-control system includes a designed prescription encoded by audio-frequency encoding technique, and then the encoded signal is burned with sounds or both sounds and images to make a sound or an image-and-sound prescription compact disk. After the sounds and images of the prescription compact disk are broadcast, an audio-frequency decoder will receive the sounds and decode them and then transmit the decoded signal to the controller of an apparatus. According to different signals and commands received, the controller will control the apparatus to make various settings which are the same as the designed contents of the prescription, thus enabling a user to carry out self-training anytime and anywhere in accordance with the designed prescription.

### BACKGROUND OF THE INVENTION

1. Field of the Invention

This invention relates to a prescription remote-control system, particularly to one having a designed prescription encoded by means of audio-frequency encoding technique and then the encoded signal burned with sounds to make up an image-and-sound prescription compact disk. After the sounds of the image-and-sound prescription compact disk are broadcast, an audio-frequency decoder will receive the sound signal and decode it and then transmit the decoded signal to the controller of an apparatus a user uses. Then the controller commands the apparatus to set different programs according to the different signals the controller receives. The different programs set by the apparatus are the same as the contents of he design that the prescription makes, and a user can precede exercise guided by the contents.

2. Description of the Prior Art

Generally, apart from being equipped with various kinds of sports apparatus to be used, a sports club also provides music and films for people to listen and watch while they are taking exercise to let them avoid feeling monotonous. In addition, professional coaches in a sports club always design a sports prescription, such as patterns of exercise and adjustment of resistance, degree of slope and velocity of the sports apparatus, in accordance with personal physical conditions and requirements so as to avoid sports injuries and achieve an excellent ports effect. However, constantly going to the sports club for exercise would take much time and also cost much money, resulting in much inconvenience to the exercisers.

### SUMMARY OF THE INVENTION

The objective of the invention is to offer a prescription remote-control system which enables a user to carry out self-training anytime and anywhere in accordance with a designed prescription.

The feature of the invention is to have a designed prescription encoded by means of audio-frequency encoding technique. Then, the encoded signal burned with sounds only or both sounds and images to make up a sound prescription compact disk or an image-and-sound prescription compact disk. After the sounds of the sound prescription compact disk are broadcast, an audio-frequency decoder will receive and decode the sound signals and then transmit the decoded signals to the controller of an apparatus to let the controller command the apparatus to carry out the functions designed by the prescription, enabling a user to carry out self-training anytime and anywhere according to the designed prescription.

### BRIEF DESCRIPTION OF DRAWINGS

This invention will be better understood by referring to the accompanying drawings, wherein:

FIG. 1 is a flow chart of a prescription remote-control system in the present invention.

### DETAILED DESCRIPTION OF THE PREFERRED EMBODIMENT

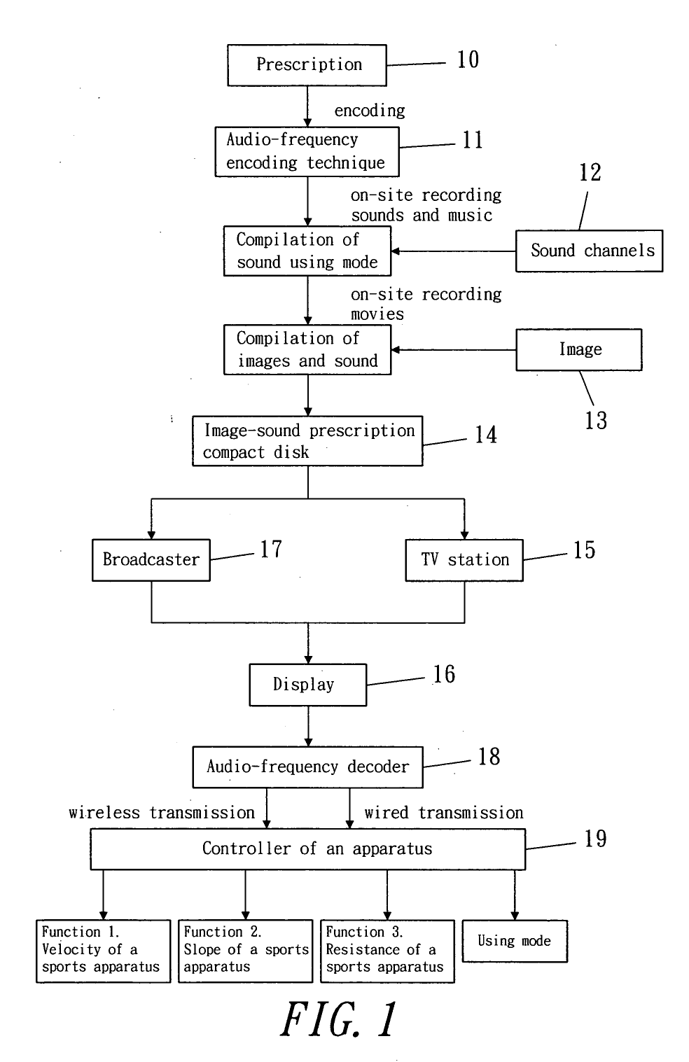

A preferred embodiment of a prescription remote-control system in the present invention, as shown in FIG. 1, includes a designed prescription 10, such as a sports prescription designed by a sports coach. The prescription 10 is encoded to form an audio-frequency signal by means of audio-frequency encoding technique 11, such as DTMF (dual tone multi-frequency) encoding technique. Then, the encoded signal is burned with sounds 12 and images 13 and compiled to make up an image-and-sound prescription compact disk 14. The contents of the image-sound prescription compact disk 14 can be transmitted to a consumer's display 16 (TV set) via a TV station and then broadcast and indicated by the display 16. The image-and-sound prescription compact disk 14 can also be directly deposited in a broadcaster 17 (a projector) and broadcast and indicated through the display 16 (TV set). After the images and sounds are broadcast and indicated, the audio-frequency signal will be decoded by an audio-frequency decoder 18 (such as a DTMF decoder). Then, the decoded audio-frequency signal is transmitted to the controller 19 (such as an electronic watch) of an apparatus (such as a sports apparatus) by means of wired or wireless transmission to let a controller 19 control the movement patterns of the apparatus and adjust the resistance, the degree of slope and the velocity of a sports apparatus.

In using, a user can take exercise with an apparatus (such as a sports apparatus) in accordance with the movement patterns designed by the image-and-sound prescription and simultaneously watch the image on the display and also listen to the music broadcast by the display 16. In addition, after the controller 19 of an apparatus receives the command of the audio-frequency signal decoded by the audio-frequency decoder 18, it will control the apparatus to make various settings, such as change of resistance, slope and velocity as well as sports patterns of a sport apparatus, which are the same as the contents designed by the prescription 10. Therefore, the apparatus can be controlled to accomplish the designed contents of the prescription by the audio-frequency signal.

In order to obtain effects of high-transmission velocity and anti-interference, the audio-frequency encoding technique 11 and the decoder 18 can employ a combined signal of two specific single-audio-frequency to represent the single-digital DTMF encoding technique for encoding and decoding. The DTMF code is extensively applied to telephone system, having excellent capacities for anti-interference and transmission velocity.

The image-sound prescription compact disk 14 is made by having the audio-frequency encoded signal burned with sounds. Therefore, if the audio-frequency encoded signal is burned with the actual sound effects and the songs and also with the images of actual scenes of the group sport or TV programs or films to make up an image-sound prescription compact disk 14, a user can take exercise according to the exercise patterns designed by the image-sound prescription compact disk 14 and listen to the music at the same time, enjoying amusements as well as exercise. The prescription compact disk 14 can also be burned with sounds of language teaching to achieve an educational function of language learning. Further, if the sounds and images input are scenes of group activity, a user will feel as if he were present in the group at that time.

There are two ways for the audio-frequency decoder 18 to transmit the audio-frequency signal to the controller 19 of an apparatus: wired transmission and wireless transmission. The wired transmission is carried out by means of RS232C transmission lines (BUS) and transistor-to-transistor transmission lines (12C). The wireless transmission is to have the decoded audio-frequency signal converted into RF ultra-red rays and then transmitted to the controller 19 of the apparatus.

When the prescription remote-control system in the present invention is applied to a sports apparatus, it is able to combine teaching physical exercise with amusement together. Thus, a user can take exercise and listen to music or learn lessons at the same time as if there were a coach standing by and instructing him. Further, the prescription remote-control system in the present invention can also be applied to musical instruments. After the sounds of the image-sound prescription compact disk are broadcast, the audio-frequency decoder will transmit the decoded signal to the controller of the musical instrument to let the controller manage playing of the musical instrument to guide a learner to do exercise at the musical instrument.

While the preferred embodiment of the invention has been described above, it will be recognized and understood that various modifications may be made therein and the appended claims are intended to cover all such modifications that may fall within the spirit and scope of the invention.

1. A prescription remote-control system comprising a designed prescription, said designed prescription encoded by means of audio-frequency encoding technique, said encoded signal burned with sounds to make up a image-and-sound prescription compact disk, the sounds of said sound prescription compact disk broadcast, an audio-frequency decoder receiving said broadcast sounds and decoding them, said decoded signal transmitted to the controller of an apparatus a user employs, said controller managing said apparatus to make various settings according to different command signals received, said various settings of said apparatus being the same as the designed contents of said prescription.

2. The prescription remote-control system as claimed in claim 1, wherein said encoded signal is burned with sounds and images to make up an image-and-sound prescription compact disk.

3. The prescription remote-control system as claimed in claim 1, wherein a dual tone multi-frequency (DTMF) encoding technique and a decoder extensively applied to a common telephone system can serve as said audio-frequency encoding technique and said audio-frequency decoder.

4. The prescription remote-control system as claimed in claim 1, wherein the images and sounds of said image-and-sound prescription compact disk are emitted by a TV station and transmitted to a consumer's display to be broadcast.

5. The prescription remote-control system as claimed in claim 1, wherein the images and sounds of said image-and-sound prescription compact disk is broadcast by a display through a broadcaster.

6. The prescription remote-control system as claimed in claim 1, wherein an electronic watch of a sports apparatus can serve as said controller.
